(19) United States
(12) Patent Application Publication
(10) Pub. No.: US 2026/0217528 A1
(43) Pub. Date: Jul. 30, 2026

(54) METHOD AND APPARATUS FOR LIQUEFYING AND/OR SEPARATING A MIXTURE CONTAINING CO2

(71) Applicant: L'Air Liquide, Societe Anonyme pour l'Etude et l’Exploitation des Procedes Georges Claude, Paris (FR)

(72) Inventors: Michael TRAN, Champigny Sur Marne (FR); Laura RICCI, Champigny Sur Marne (FR); Richard DUBETTIER-GRENIER, Champigny Sur Marne (FR)

(21) Appl. No.: 19/137,118

(22) PCT Filed: Nov. 30, 2023
(86) PCT No.: PCT/EP2023/083717

§ 371 Date: Jun. 9, 2025

(30) Foreign Application Priority Data
Dec. 13, 2022 (FR) FRFR2213261

(51) Int. Cl. C01B 3/506; C01B 32/50; F25J 3/02; F25J 3/06

(52) U.S. Cl. CPC C01B 3/506; C01B 32/50; F25J 3/0223; F25J 3/0266; F25J 3/0625; F25J 3/067; C01B 2203/046; C01B 2203/0475; F25J 2270/906

(57) ABSTRACT

The invention relates to a method for separating by distillation and/or partial condensation a mixture of carbon dioxide, wherein a gas (23) of a refrigeration cycle that cools the mixture upstream of the separation is cooled by a refrigerant flow (26) and the mixture is then separated by partial condensation and/or distillation, the refrigerant flow being produced by an absorption refrigeration unit (50), the heat source of which is a fluid (21) heated by the heat from converting a synthesis gas from CO to CO2, the conversion producing a synthesis gas enriched with CO2, which is the mixture to be cooled (16).

### CROSS REFERENCE TO RELATED APPLICATIONS

This application is a § 371 of International PCT Application PCT/EP2023/083717, filed Nov. 30, 2023, which claims the benefit of FR2213261, filed Dec. 13, 2022, both of which are herein incorporated by reference in their entireties.

### FIELD OF THE INVENTION

The present invention relates to a process and apparatus for liquefying and/or separating by distillation and/or partial condensation a mixture containing CO2.

The present invention relates in particular to a process for producing a carbon dioxide rich stream from a syngas. In particular, the invention relates to a process for recovering fatal heat from a hydrogen production plant or an integrated gasification combined cycle (IGCC) power plant.

### BACKGROUND OF THE INVENTION

Syngas is a mixture of gases including carbon monoxide, hydrogen and carbon dioxide, often generated by steam methane reforming (SMR) or autothermal reforming (ATR) or gasification (POX or other) processes. Depending on the raw material used, the syngas produced may comprise water vapor (H2O), hydrogen cyanide (HCN), carbon dioxide (CO2), nitrogen (N2), oxygen (O2), methane (CH4), hydrogen sulfide (H2S), carbonyl sulfide (COS), ammonia (NH3), hydrochloric acid (HCl), argon (Ar), mercury (Hg), hydrocarbons, heavy hydrocarbons such as tars, particulates containing coal, ash and/or unconverted fuel. It can also be generated in the process of an integrated gasification combined cycle power plant.

The invention applies to the separation of any gas stream containing carbon dioxide, hydrogen and carbon monoxide, this stream being designated by the syngas stream.

The carbon monoxide present in syngas is often converted into carbon dioxide by a water gas shift process. Carbon monoxide (CO) is essentially converted into additional hydrogen and carbon dioxide under the action of water vapor and in the presence of a suitable catalyst. In the state of the art, to promote this conversion, a large excess of steam (relative to the stoichiometry of the reaction) is introduced.

However, the energy available at lower temperatures (less than 170° C.) available in the syngas at the shift module outlet generally remains unused. The excess steam compared to stoichiometry increases this excess heat available at the outlet.

Depending on the units, the amount of energy still available in these fluids is of the order of 2 to 20 MWth corresponding to production units of 10 000 Nm³/h H2 to 100 000 Nm³/h H2. This energy is currently evacuated—and thus lost—by generally using one or more of the following solutions:
direct smoke emission (at temperatures of 120 to 170° C.),
heat exchange against ambient air in air coolers, and/or
heat exchange against cooling water which will itself be either returned directly to the natural environment (taking into account temperature constraints) or cooled against ambient air in cooling towers.

Syngas from which at least a portion of the CO has been converted into CO2 may be processed to produce a gas from which the CO₂ is separated by partial condensation and/or distillation. It can be processed by pressure swing adsorption (PSA) to produce hydrogen and waste gas. The PSA waste gas contains CO2, H2, CH4, N2 but also CO because the conversion of CO into H2 in the shift step preceding PSA is not complete.

Apparatus of this type is described in “Start-up of Port-Jerôme CRYOCAP® Plant” by Pichot et al., Energy Procedia 114 (2017).

Alternatively, it can be treated by absorption (Selexol®, Rectisol®, amine scrubbing) to remove an acid gas it contains such as H2S to produce a syngas purified of H2S. A permeation treatment could make it possible to produce hydrogen.

A low temperature separation unit, by partial condensation and/or distillation, separates the waste gas or syngas purified of H2S and produces:
CO2 (in liquid or gaseous form)
waste gases containing CO and H2 from the steps of partial condensation of the waste gas and/or distillation at temperatures below 0° C. of the CO2.

A low temperature separation is performed at a temperature below 0° C. so a cooling step is necessary upstream of the separation.

The separation may be solely by partial condensation as described in “CO2 Capture from IGCC by Low Temperature Synthesis Gas separation” by Berstad et al., Energies 2022, 15, 515 and WO 2022/131 925.

It is known practice from WO 2006/054 008 to convert CO from a syngas into CO2, to separate the syngas by adsorption forming a CO2-enriched and hydrogen-depleted gas and to separate out the CO2-enriched gas by partial condensation.

### SUMMARY OF THE INVENTION

The aim of the present invention is to reduce the energy consumption of a process for separating a mixture containing CO2 by using the heat generated by a process for converting CO into CO2 by the reaction

$$CO + H2O ⇔ CO2 + H2¶ \qquad [ Math 1 ]$$

The exothermic reaction produces a temperature level of between 15° and 450° C.

The conversion process also produces a CO2-enriched fluid that will be processed to generate the mixture.

The heat generated by the conversion process is converted into cold by an absorption or adsorption refrigeration unit.

The absorption refrigeration machine is divided into four main components:
1. the evaporator,
2. the absorber,
3. the concentrator,
4. the condenser.
1. In the evaporator, the refrigerant (here water) is sprayed in a very low pressure environment. The evaporator is traversed by a water circuit. On evaporating, the refrigerant subtracts heat from this water, which is thus cooled. Some of the sprayed refrigerant does not evaporate and falls to the bottom of the evaporator where it is pumped to be sprayed again.
2. The water vapor created in the evaporator is fed to the absorber. It contains the absorbent solution (for example LiBr) which is continuously pumped into the bottom of the container for spraying. The absorbent solution absorbs water vapor outside the evaporator and thus maintains the low pressure therein (preferably below atmospheric pressure) necessary for vaporizing the refrigerant.
As it absorbs the water vapor, the absorbent solution is increasingly diluted. It would eventually be saturated and no longer be able to absorb anything.
3. The solution is therefore regenerated in the concentrator. It is heated by a hot water exchanger (about 85° C.) and some of the water evaporates. The regenerated solution returns to the absorber.
4. Finally, the water vapor extracted from the concentrator is brought into the condenser, where it is cooled by a circulation of cold water. The condensed water returns to the evaporator.

This heat transfer between a syngas processing plant and a process for separating a mixture containing CO₂, which is the treated syngas or which is produced by separating the treated syngas, also has the following advantages:
the absence of rotating machinery in the refrigeration unit
the use of fatal heat
good thermal efficiency.

According to one subject of the invention, a process is provided for liquefying and/or separating by distillation and/or partial condensation a carbon dioxide mixture in which
i) the mixture is cooled upstream of the separation and/or liquefaction and/or
ii) a gas from a refrigeration cycle that cools the mixture upstream of the separation and/or liquefaction is cooled by a refrigerant stream and the mixture is then liquefied and/or separated by partial condensation and/or distillation, the refrigerant stream being produced by an absorption or adsorption refrigeration unit whose heat source is a fluid heated by the heat of a conversion of CO to CO2 of a syngas, the conversion producing a CO2-enriched syngas which is the mixture to be cooled or which is separated by absorption or adsorption to form the mixture to be cooled.

According to other optional aspects:
the mixture is separated by distillation and/or partial condensation
the mixture is liquefied
the mixture is cooled by a refrigeration cycle
the mixture is cooled by a refrigeration cycle other than that of the cooler
the mixture cooled by the refrigerant stream, either directly or through the refrigeration cycle, is then cooled in a heat exchanger by heat exchange with at least one fluid produced by separating the mixture by partial condensation and/or distillation
the mixture cooled by the refrigerant stream, either directly or through the refrigeration cycle, is then heated in a heat exchanger by heat exchange with at least one fluid
the refrigeration cycle cools the mixture to be separated in the heat exchanger
the mixture or cycle gas is cooled by the refrigerant stream to a temperature below 20° C., preferably below 10° C.
the mixture or cycle gas is cooled by the refrigerant stream to a temperature above 0° C.
the cycle gas is predominantly carbon dioxide (therefore contains more than 50 mol % of CO2), the maximum pressure of which is subcritical and preferably below 65 bar abs, typically below 50 bar abs, or even below 40 bar abs
the refrigeration unit is an absorption refrigeration unit of the binary mixture type, for example water/lithium bromide or ammonia/water
the refrigeration unit is a single, double or triple-pass cooler
the heated fluid is at a temperature of between 120° C. and 250° C., preferably above 150° C., or even above 180° C.
the heated fluid is at a temperature of between 300 and 450° C.
the heated fluid is water in liquid form or water vapor
the syngas is produced by an integrated gasification combined cycle power plant or a partial oxidation reformer
one portion of the refrigerant stream is used to cool the mixture and/or cycle gas and another portion is used to cool the syngas after the CO has been converted into CO2
the coefficient of performance of the refrigeration unit is between 0.3 and 3 and preferentially between 0.5 and 1.8
the mixture to be cooled contains at least 10 mol %, preferably at least 50 mol % or even at least 90 mol % of CO2.

The coefficient of performance is defined as the ratio between the cooling power and the heat received.

The absorption refrigeration unit can be of the single-pass type as described below or double-pass type (by having an absorber and an additional auxiliary generator to increase the efficiency of the system) or even triple-pass type.

A double-pass refrigeration unit will preferably be chosen for the application of this invention, but a single-pass or a triple-pass unit is also possible.

According to another subject of the invention, apparatus is provided for liquefying and/or separating by distillation and/or partial condensation a carbon dioxide mixture, comprising:
i) means for cooling the mixture upstream of the separation and/or liquefaction and/or
ii) a refrigeration cycle comprising means for indirectly contacting a gas of the refrigeration cycle and the mixture to cool the mixture upstream of the separation and/or liquefaction and
means for liquefying the mixture and/or for separating the mixture by distillation and/or partial condensation
an absorption or adsorption refrigeration unit connected to send a refrigerant stream to the means for cooling the mixture and/or to a heat exchanger for cooling the cycle gas, the unit being connected to a heat source which is a fluid heated by the heat of a CO to CO2 conversion of a syngas in a reactor, means for sending CO2-enriched syngas from the reactor as a mixture to be cooled or for sending CO2-enriched syngas from the reactor to an absorption or adsorption unit to form the mixture to be cooled.

The apparatus may comprise a heat exchanger, means for sending at least one fluid produced by the separation of the mixture by partial condensation and/or distillation to the exchanger for heating and means for sending the mixture cooled by the refrigerant stream to be cooled in the heat exchanger.

Preferably, the refrigeration cycle is connected to the heat exchanger to cool the mixture to be separated.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The invention will be described in greater detail with reference to the figures, in which:

FIG. 1 shows a syngas treatment process comprising a syngas shift.

FIG. 2 shows a hydrogen production process comprising a syngas shift.

FIG. 3 shows a cooling process upstream of liquefaction or separation of a carbon dioxide mixture by distillation and/or partial condensation.

### DETAILED DESCRIPTION OF THE INVENTION

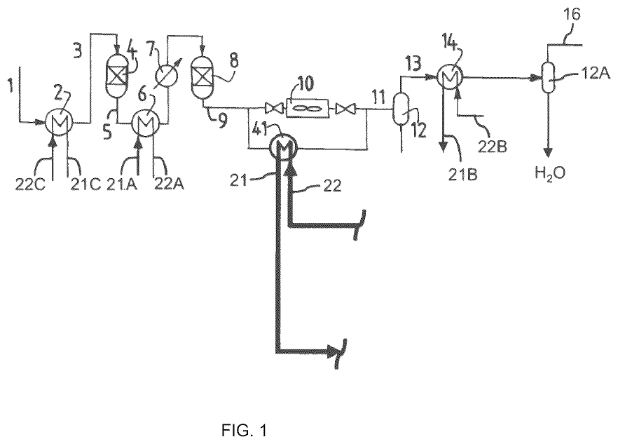

The diagram of FIG. 1 reproduces only part of the elements composing a syngas treatment plant: only those elements which are useful to the understanding of the invention are reproduced; in particular, certain heat exchangers which do not participate in the invention have not been represented. In order to facilitate the understanding of the figure, certain compressors, valves, and also connecting and control elements which are known to those skilled in the art and which would unnecessarily burden the diagram have also been omitted.

According to the process of the invention as shown in FIG. 1, syngas 1 from a source, such as an integrated gasification combined cycle (IGCC) power plant, leaves the reformer at elevated temperature and pressure. In the case of syngas from such a plant, its CO2 content is between 5 and 10 mol % on a dry basis. It is cooled against steam (or water) 22C in 2, the thus cooled syngas 3 passes through a high or medium temperature shift reactor (HT) 4 (220-450° C.), the shifted gas 5 is cooled again in 6 by the fluid 21A, then in 7 the two coolings 6 and 7 together constituting a second cooling; it should also be noted that according to this example, the cooled syngas is shifted again here in a low temperature shift reactor (BT) (180 to 250° C.) in 8; the syngas 9 leaving the shift module is at a temperature of between 125° C. and 260° C. The heat still present in the syngas 9 thus constitutes a first part of the fatal heat of the plant. It is also possible to use a medium temperature (220-270° C.) shift step.

In a conventional manner, the temperature of the syngas is then lowered by passing through air coolers 10, thus making it possible to obtain a syngas 11 at a temperature of the order of 80 to 85° C. The syngas contains condensates which in 12 are separated from the dry syngas 13 (i.e. freed of the liquid water contained therein). The dry syngas 13 is cooled a last time in 14 against raw cooling water (about 20° C.), new condensates are thus obtained which are separated to form a new dry syngas 16 at between 20 and 40° C., about 18 to 30 bar containing between 15 and 35 mol % of CO2.

The gas 16 can then be treated to remove impurities such as H2S by absorption, for example by physical absorption, such as Selexol®. Alternatively, this purification can take place upstream of shift 4 or 8. In this case, the function of the exchanger 2 of FIG. 1 may be to heat the desulfurized syngas 3 coming from this absorption unit, mixed with the steam which will then react in the unit 4. Moreover, in this case, considering the large quantity of CO to be converted, the shift unit 8 can also operate at high temperature (300-450° C.).

It should also be noted that the heat recovery on the gases leaving the shift units can be used to heat the syngas or the syngas water/steam mixture 3 upstream of the shift unit 4.

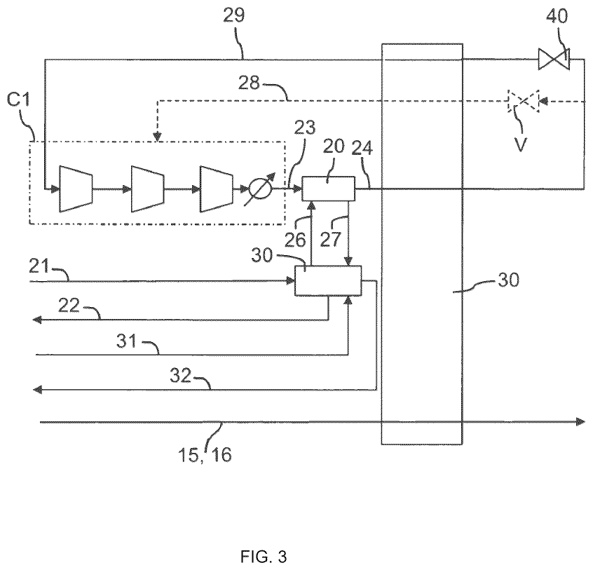

The H2S-purified gas 16 is then dried, for example by adsorption (not shown) and sent to a cooling process upstream of a liquefaction or separation of a carbon dioxide mixture by distillation and/or partial condensation as shown in FIG. 3. The elements of the liquefaction or separation process are not described in detail but are well known. Upstream of the separation, it is necessary to cool the gas 16 in a heat exchanger 30 and the cooled gas is then sent to a phase separator and/or to a distillation column to produce carbon dioxide in gaseous and/or liquid form or else liquefied. In this example, gas 16 is cooled using a closed refrigeration cycle, which can be a cycle using CO2 as the cycle gas. The cycle gas 29 is compressed in a cycle compressor C1, here with three stages, to a subcritical pressure and preferably below 65 bar abs, typically below 50 bar abs, or even below 40 bar abs. At this pressure, it is cooled by coolers 20 and then cooled in exchanger 30, before being expanded in a valve 40 before being sent back to exchanger 30 to rejoin compressor C1. Alternatively, part 28 of the cycle gas cooled in the heat exchanger 30 can be expanded to a pressure higher than that produced by the valve 40 in a valve V and sent to the outlet of one of the compression stages, the choice being free as symbolized by the dotted lines.

Here, the cycle gas is cooled using a cooler 50 which is an absorption refrigeration unit. This cooler 50 receives a gas 21 heated by the shifted gas 9 as a heat source. It is also supplied with cooling water 31 at between 20 and 60° C. which leaves cooler 50 as heated fluid 32. Having transmitted its heat, the gas 22 returns to the exchanger 41 of FIG. 1 to cool the shifted syngas 9. The cooler cools a fluid 27, for example water, coming from a heat exchanger 20 producing a cooled fluid 26 which is returned to heat up in the exchanger 20. The exchanger 20 can be a tube and shell exchanger, a plate exchanger or a brazed aluminum exchanger. The cycle gas stream 23 cools in the heat exchanger 20 to a temperature below 20° C. or even below 15° C. The temperature is preferably above 0° C. to avoid the risk of freezing. The cycle gas at this temperature 24 is sent to cool in the heat exchanger 30. This configuration saves 1.1 kWh/t of CO2 per° C. of temperature reduction of the stream 24, which corresponds to a 1% reduction in energy consumption.

Alternatively, the cooler 50 can be used to cool directly the stream 16 upstream of the heat exchanger 30. In this case, the stream 16 is at a subcritical pressure and preferably below 65 bar abs, typically below 50 bar abs, or even below 40 bar abs. It is cooled by the cooler 50 to a temperature below 20° C. or even below 20° C., for example, by sending a cooled fluid equivalent to the fluid 26 to a heat exchanger equivalent to the exchanger 20 in which the mixture to be separated circulates in order to be cooled. The temperature of the mixture 16 leaving this exchanger is preferably greater than 0° C. to avoid the risk of freezing.

It is obvious that the cooler 50 can simultaneously cool the compressed cycle gas 23 and the mixture 15 to be separated. The cold water 26 produced by the cooler can also be used to cool other elements of the process.

Alternatively, the heat for the cooler can come from the first shift step in the reactor 4: in this case, it is the fluids 21A, 22A (hot gas, water or steam) that transfer the heat to the cooler 50.

The fluids 21 and 21A can be mixed to provide heat to the cooler.

In addition, the fluids 21B heated by the shifted syngas 13 and/or 21C heated by the syngas 1 intended for the reactor 4 can supply heat to the cooler 50. The fluid 21C is heated in the heat exchanger 2 and the fluid 22C cooled in the cooler 50 returns therein to cool the syngas. The fluid 21B is heated in the heat exchanger 14 and the fluid 22C cooled in the cooler 50 returns therein to cool the syngas.

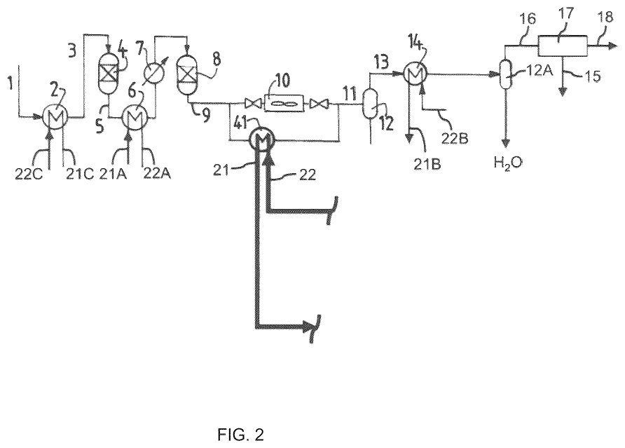

In the variant of FIG. 2, the new dry syngas 16 (25° C., 18 to 30 bar approximately) is then sent to the PSA H2 unit 17 to be separated by pressure swing adsorption to produce hydrogen 18 and a waste gas 15 that is hydrogen-depleted and CO2-enriched relative to gas 16. It is this waste gas 15 which is sent to the apparatus of FIG. 3 to be cooled. It preferably contains between 10 and 75 mol % of CO2.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-13. (canceled)

14. A process for liquefying and/or separating by distillation and/or partial condensation a carbon dioxide mixture, the process comprising the steps of:
i) performing at least one of the following steps:
a. cooling the carbon dioxide the mixture (15, 16) upstream of the separation and/or liquefaction; and/or
b. cooling a cycle gas (23) from a refrigeration cycle that cools the carbon dioxide mixture upstream of the separation and/or liquefaction by a refrigerant stream (26); and
ii) liquefying and/or separating the carbon dioxide mixture,
wherein the refrigerant stream is produced by an absorption or adsorption refrigeration unit (50) whose heat source is a fluid (21, 21A, 21B) heated by the heat of a conversion of CO to CO2 of a syngas (1, 3, 5), the conversion producing a CO2-enriched syngas (5, 9) from which the carbon dioxide mixture (16) to be cooled is derived.

15. The process as claimed in claim 14, wherein the mixture cooled by the refrigerant stream (26), either directly or through the refrigeration cycle, is then cooled in a heat exchanger (30) by heat exchange with at least one fluid produced by separating the mixture by partial condensation and/or distillation.

16. The process as claimed in claim 15, wherein the refrigeration cycle (29) cools the carbon dioxide mixture (15, 16) to be separated in the heat exchanger.

17. The process as claimed in claim 14, wherein the carbon dioxide mixture (15, 16) or the cycle gas (23, 29) is cooled by the refrigerant stream (26) to a temperature below 20° C., preferably below 10° C., but preferably above 0° C.

18. The process as claimed in claim 14, wherein the cycle gas (23, 29) is predominantly carbon dioxide, the maximum pressure of which is subcritical and preferably below 65 bar abs, typically below 50 bar abs, or even below 40 bar abs.

19. The process as claimed in claim 14, wherein the refrigeration unit (50) is an absorption refrigeration unit of the binary mixture type, for example water/lithium bromide or ammonia/water.

20. The process as claimed in claim 14, wherein the refrigeration unit (50) is a single-pass, double-pass or triple-pass cooler.

21. The process as claimed in claim 14, wherein the heated fluid (21) is at a temperature of between 120° C. and 250° C., preferably above 150° C. or even above 180° C.

22. The process as claimed in claim 14, wherein one portion of the refrigerant stream (26) is used to cool the carbon dioxide mixture (15, 16) and/or the cycle gas (23, 29) and another portion is used to cool the syngas (5, 9) after conversion of the CO to CO2.

23. The process as claimed in claim 14, wherein the coefficient of performance of the refrigeration unit (50) is between 0.3 and 3 and preferentially between 0.5 and 1.8.

24. An apparatus for liquefying and/or separating by distillation and/or partial condensation a carbon dioxide mixture, the apparatus comprising:
i) means for cooling the carbon dioxide mixture (15, 16) upstream of the separation and/or liquefaction; and/or
ii) a refrigeration cycle (23, 29) comprising means (30) for indirectly contacting a gas of the refrigeration cycle and the carbon dioxide mixture to cool the carbon dioxide mixture upstream of the separation and/or liquefaction;
iii) means for liquefying the carbon dioxide mixture and/or for separating the carbon dioxide mixture by distillation and/or partial condensation; and
iv) an absorption or adsorption refrigeration unit (50) connected to send a refrigerant stream to the means for cooling the carbon dioxide mixture (15, 16) and/or to a heat exchanger (20) for cooling the cycle gas, the unit being connected to a heat source which is a fluid (21, 21A, 21B) heated by the heat of a CO to CO2 conversion of a syngas (3, 5) in a reactor (4, 8), means for sending CO2-enriched syngas from the reactor as a mixture (16) to be cooled or for sending CO2-enriched syngas from the reactor to an absorption or adsorption unit (17) to form the carbon dioxide mixture (15) to be cooled.

25. The apparatus as claimed in claim 24, further comprising a heat exchanger, means for sending at least one fluid produced by the separation of the carbon dioxide mixture by partial condensation and/or distillation to the exchanger for heating and means for sending the carbon dioxide mixture cooled by the refrigerant stream (26) to be cooled in the heat exchanger (30).

26. The apparatus as claimed in claim 24, wherein the refrigeration cycle (29) is connected to the heat exchanger to cool the carbon dioxide mixture (15, 16) to be separated.

27. A method for reducing the energy consumption of a carbon dioxide separation or liquefaction process, the method comprising the steps of:
a) performing a water-gas shift reaction on a syngas stream to convert carbon monoxide into carbon dioxide, thereby generating a CO₂-enriched syngas and releasing process heat;
b) transferring at least a portion of the process heat via a heat transfer fluid to a heat-activated refrigeration unit;
c) operating the heat-activated refrigeration unit using said process heat to produce a primary refrigerant stream;
d) providing a process gas stream rich in carbon dioxide, wherein said process gas stream is derived from the CO₂-enriched syngas;
e) using the primary refrigerant stream to cool a target fluid, wherein the target fluid is at least one of: i. the process gas stream; or ii. a cycle gas of a secondary refrigeration cycle used to cool the process gas stream; and
f) subsequently separating or liquefying carbon dioxide from the cooled process gas stream.

28. The method as claimed in claim 27, wherein the process gas stream is the CO₂-enriched syngas produced in step (a).

29. The method as claimed in claim 27, wherein the CO₂-enriched syngas is further processed in a pressure swing adsorption (PSA) unit to produce hydrogen and a waste gas, and wherein the process gas stream is said waste gas.

30. The method as claimed in claim 27, further comprising the step of passing the cooled process gas stream through a heat exchanger to be further cooled by at least one product stream from the separation or liquefaction step.

31. The method as claimed in claim 27, wherein the target fluid is cooled by the primary refrigerant stream to a temperature below 20° C. and above 0° C.

32. The method as claimed in claim 27, wherein the heat-activated refrigeration unit is an absorption refrigeration unit utilizing a binary mixture, such as water/lithium bromide or ammonia/water.

33. The method as claimed in claim 27, wherein the heat transfer fluid supplied to the heat-activated refrigeration unit is at a temperature between 120° C. and 250° C.

34. The method as claimed in claim 27, wherein the target fluid is the cycle gas of a secondary refrigeration cycle, and wherein said cycle gas is predominantly carbon dioxide at a subcritical pressure below 65 bar absolute.
